(19) United States
(12) Patent Application Publication
(10) Pub. No.: US 2006/0149810 A1
(43) Pub. Date: Jul. 6, 2006

(54) Method and procedure in creating a server side digital image file as receipt for web transactions

(76) Inventors: Sing Chi Koo, Cupertino, CA (US); Connie Lai Ying Chun, Cupertino, CA (US)

Correspondence Address: Sing Chi Koo, 10139 Mello Place, Cupertino, CA, 95104, US

(21) Appl. No.: 11/029,877

(22) Filed: Jan. 5, 2005

(51) Int. Cl. G06F 15/16; G06Q 99/00

(52) U.S. Cl. 709/203; 705/50

(57) ABSTRACT

A method and procedure in creating a receipt by a Web server (10) for a Web based transactional application (11) by drawing data (51) from a Web transaction onto a pre-defined template image (FIG. 3B), making the resulting digital image file (FIG. 3D) available to the Web client (16) or e-mail client (19) as a receipt document for the transaction (17).

### BACKGROUND—FIELD OF THE INVENTION

This invention relates to the Web based transactions, more specifically the present invention uses a digital image file created dynamically by a Web Server to improve the integrity of confirmation receipt.

### BACKGROUND—DISCUSSION OF PRIOR ART

Most e-commerce applications rely on the World Wide Web to deliver services and goods. A Web transaction encapsulates an instance of the purchase and sales of services and goods over the World Wide Web. The conclusion of a Web transaction normally resulted in a receipt prepared by the Web server, make available to the client. The receipt serves as a recap of the transaction. Web transaction is commonly used in online commercial applications such as banking, brokerage, institutional services, school and college admissions, and countless number of e-commerce applications. This breed of applications fuels the growth of the World Wide Web. Billions of transactions are conducted over the Internet daily. Web based transactions are processed and recorded in Web server systems. In a Web based transaction, the Web server sends a HTML receipt to the Web client as a confirmation of the transaction. The Web client uses the print function of the Web browser to print a copy of the receipt. Many Web applications provide a printer friendly format for the Web client to obtain a printable version of the receipt. Examples of these prior arts can be found across well-known e-finance and e-commerce sites such as amazon.com, google.com, bankofamerica.com, citicorp.com, ebay.com, verisigin.com, fidelity.com, schwab.com, etc. These web sites provide receipts in HTML format as confirmation. The Web browser on the client side interprets the HTML page and creates a displayable and printable image. This approach lacks integrity. The look and feel of the receipt often depends on the browser type, resolution of the display device, and embedded hypertext links such as style sheets. This type of receipt does not provide an uniform look and feel like those provided by the brick and mortar establishments. There are prior-arts that provide methods and procedures to ensure the integrity of transmission of electronic receipts in HTML format between the sender and the receiver. However, these approaches do little to improve the integrity of the receipt printed by the Web client, interpreted from a HTML document, provided by the Web server. The authenticity of this type of receipt is subject to legal challenge. In the U.S. Pat. No. 6,067,529, Dipankar Ray et al. describes an invention of sending electronic receipt to the consumer in the form of a digital text message as a result of a sale. The Dipankar Ray invention only sends short text message. It does not cover Web transactions nor does it send any image of the receipt to the consumer's device. In the U.S. Pat. No. 6,516,996 B1, Lassi Hippelainen describes a method of using key encryption technique to ensure the integrity of electronic receipt. Again the underlying receipt is in text data form. In U.S. Pat. No. 5,960,411, Hartman et al. describes another method of conducting a purchase and sale transaction using HTML documents. The Hartman invention falls in the same category of providing the Web client with a text based receipt in the form of HTML. In the U.S. Pat. No. 6,341,353 B1, Herman et al. describes a “Trusted Agent Server” as a middleman to ensure the integrity of the transaction and receipt between the seller and the buyer. This Herman invention is also based on text based messages and receipts. In the U.S. Pat. No. 5,739,512, Tognazzini describes another method of electronic receipt delivery that is based on text message delivery via email. In the U.S. Pat. No. 6,704,733 B2, Clark et al. describes a method for a Web client to submit publications to a Web server for the purpose of electronic book distribution. Metadata is added for authorization. Once the electronic book is prepared for distribution, the electronic books are distributed to authorized users as static contents. In the U.S. Pat. No. 6,385,595 B1, Kolling et al. describes a method of statement presentment that uses a template approach to determine the contents to be presented to a previously established customer. The content is determined by back-office processing that is part of a bill payment system, not determine during a Web based transaction. It is designed as a method for periodic bill presentment so that proper contents can be prepared for presentment to the customers.

### OBJECTS AND ADVANTAGES

A paper receipt provided by a brick and mortar establishment is an official receipt. It is a legal document to settle disputes. The current invention offers Web based transactions an alternative to provide receipts with comparable integrity similar to the receipts provided by brick and mortar establishments. In the present invention, the Web server sends a receipt in the form of a digital image, not in HTML format. HTML document is not a digital image, it is a set of tags and rules embedded with the content sent by the Web server. The Web browser interprets the HTML sent by the Web server. The result is displayed on the screen. Using HTML document as receipt has many drawbacks. Information from a Web transaction is specific and dynamic in nature. For example, each Web client can configure a car from a car manufacturer's Web site with its own customized features and options. Therefore, the summary receipt of the configuration is dynamic and is distinct for each Web client. Another example is the search result from a search engine. The search engine tailors search results according to the search request and advertiser's preference. The same search request at different time may yield different search results. Furthermore, HTML documents are not portable. The final display of the document depends on the hyper text links such as graphic images and style sheets supported by the browser of the Web client. When a HTML document is saved in a Web client's hard disk and then sent as an attachment via an email; the recipient of the email may not be able to view the HTML document as expected by the sender when some of the dependent hyper text links in the HTML document are not available at the recipient's Web browser. Graphic image is consisted of a picture that is made up of pixels or image descriptive elements. Common image formats include Postscripts, GIF, PDF, JPEG, TIFF and BMP. When an image is expressed as an array of pixels, each pixel is a dot on a display surface and is the basic display unit of a graphical display screen. Common image formats express image as elements that precisely define the layout of pixels to form a graphical image. Images are destined for human viewing and not for machine to process as text data. (If the image is in TIFF format and contains content originates from text file, the image can be processed through optical character recognition, OCR, to convert the image content back to text). Content of an image cannot be altered without altering the footprint of the image file or the checksum of the image file. The present invention enables a Web server to provide a Web client with a digital image as a receipt for a given transaction. When a receipt is presented as a digital image to a Web client, it is identical to a receipt produced by a brick and mortar establishment. The printed receipt, with the exception of paper not provided by the establishment, it resembles a receipt provided by the brick and mortar establishment in every aspect, including the look and feel, scale, size, logo, fonts, and color. In addition, a digital image has the ability to host an invisible watermark for the purpose of authentication. An authenticated digital image document is less likely to face legal challenge. In contrary to digital image based receipt, receipt derived from HTML document relies on the Web browser to generate the image and is subject to abuse and alteration. Although key encryption techniques can generally prevent third parties from altering the receipt during transit, the hardcopy printout bears little value when it is being examined under a microscope for originality. An encrypted electronic receipt has to be decrypted before it can be printed or viewed by the human eyes. Once decrypted, a receipt from HTML document or a text based electronic receipt, whether produced in electronic format or in paper format, cannot be authenticated since there is no other means for authentication. Whereas in a digital image based receipt, many mechanism that is inherent to digital image file such as checksum, watermarks, tags, footprints can be used to determine its authenticity. For these reasons, institutions such as the Federal Court has set the electronic upload standard in PDF format only, while some state courts and the USPTO has adopted TIF image format as the standard for its repository. Fax copy of image is generally accepted as valid legal document, whereas documents in HTML or word processor syntax are generally not accepted as official documents. The digital image receipt offers by the present invention will add the very much needed integrity to Web based transactions.

### DRAWING FIGURE

FIG. 1 is a system diagram showing the relationship between the transactional Web server and the Web client.

FIG. 2 is a flowchart diagram showing the procedure in the creation of an image receipt for a Web based transaction.

FIG. 3A is a diagram showing data layout definition of a stock buy transaction.

FIG. 3B is a diagram showing the template image of the stock buy transaction.

FIG. 3C is a diagram showing an instance of transaction data

FIG. 3D is a diagram showing transaction data drawn onto a template image

### REFERENCE NUMERALS IN DRAWINGS

10 Transactional web server
11 Transactional server application program
12 Transaction request process
13 Receipt preparation
14 Template image files and field layout definitions
15 Internet
16 Web client engaged in a transaction dialogue with a transactional Web server
17 Image display and printing of a receipt
18 Transaction storage
19 E-mail client to receive the transaction receipt
21 Web based transaction, processing request from a Web client
22 Determine if the transaction is ready for confirmation
23 If transaction is not ready for confirmation, continue transaction dialogue with Web client
24 Prepare data fields XY co-ordinates for placement into the 2-D plane
25 Select a 2-D image according to transaction type
26 Draw data according to the XY co-ordinate onto the image plane
27 Send resulting image to the client with content-type set according to the image type.
31 Form field definitions for a stock buy application
32 Template image name and target image format
33 Account number layout definition
34 Date of transaction layout definition
35 Time of transaction layout definition
36 Stock symbol layout definition
37 Number of share layout definition
38 Price per share layout definition
39 Total amount layout definition
41 Stock buy image x co-ordinate
42 Stock buy image y co-ordinate
43 Account number field location
44 Date field location
45 Time field location
46 Stock symbol location
47 Number of share location
48 Price per share location
49 Total amount location
51 Transaction data
52 Form name
53 Account number data
54 Date data
55 Time data
56 Stock symbol data
57 Number of share data
58 Price per share data
59 Total amount data
61 X co-ordinate of the resulting image
62 Y co-ordinate of the resulting image
63 Account number drawn onto the resulting image
64 Date drawn onto the resulting image
65 Time onto the resulting image
66 Stock symbol onto the resulting image
67 Number of share onto the resulting image
68 Price per share onto the resulting image
69 Total amount onto the resulting image

### SUMMARY

The present invention addresses the deficiency associated with existing prior-arts mentioned above. In accordance with the present invention, a digital image is created as a receipt for the Web based transaction.

### DESCRIPTION OF INVENTION

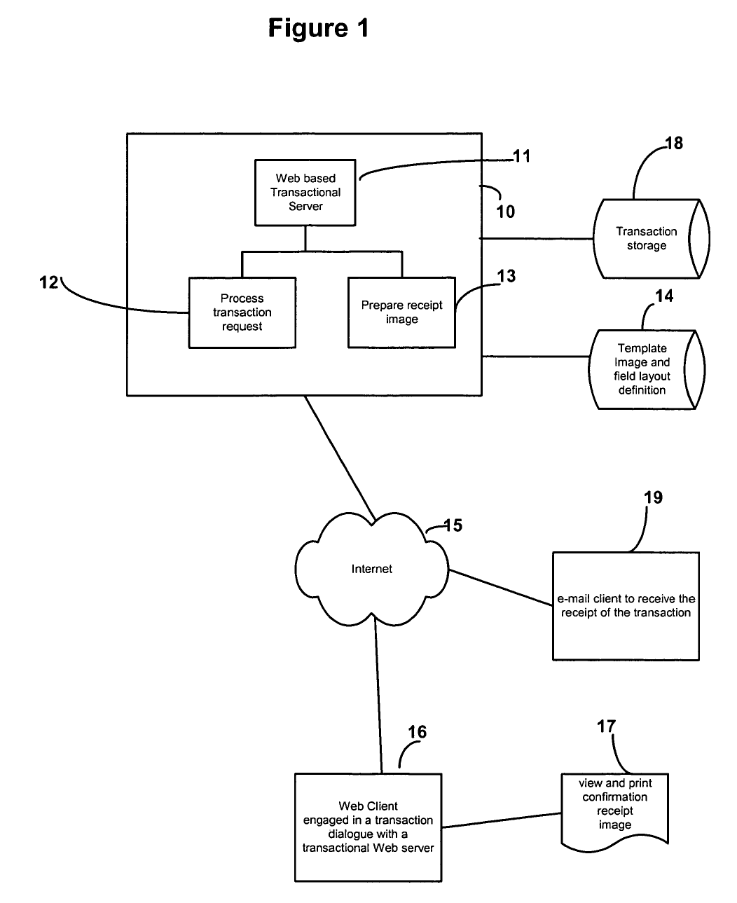

FIG. 1 shows the system diagram of a Web based diagram. An application program 11 residing in a Web server 10 provides services to process a Web based transaction 12 and upon the confirmation of the transaction, program 13 prepares receipt image by fusing a pre-defined template image and field layout definitions 14 with the data 18 from the transaction process 12. The Web server is connected to the Internet 15. A Web client 16 submits a Web based transaction to the Web server 10, upon confirmation it receives a receipt in the form of a digital image 17.

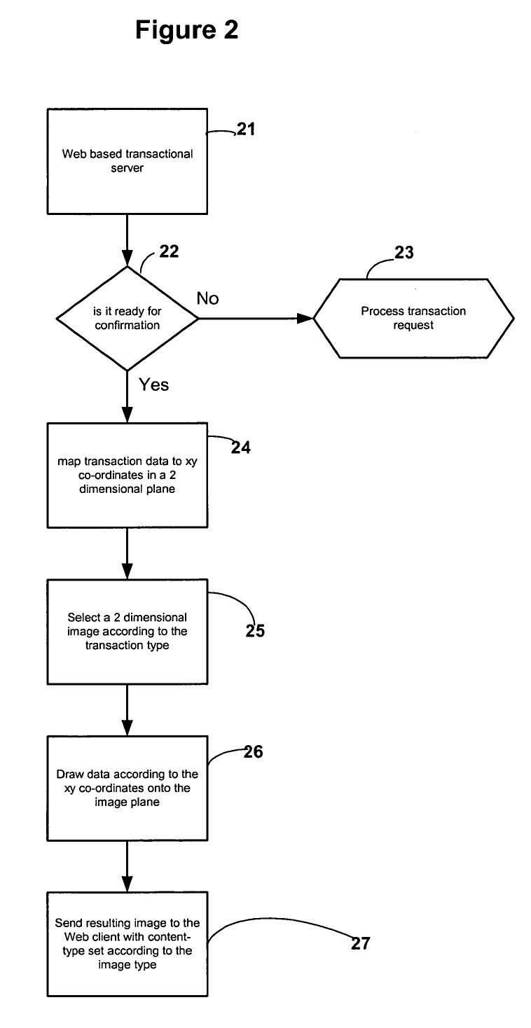

FIG. 2 shows a flow chart diagram that describes the procedure used in preparing the digital image file as the confirmation receipt which is made available to the Web client 27 for display and printing 17. The transaction processing routine 21 determines if the transaction is complete 22. If more dialogue is pending 23, it will continue the dialogue with the Web client. When it is ready for confirmation 24 the data definition for the transaction and the template image 25 are retrieved. The template image is then loaded into the computer memory. For each of the data field which is to be included in the receipt, the attributes such as XY co-ordinate, font, color, point size are used to draw the value of the data field onto the template image 26 that is loaded in the memory. The resulting image is then converted to a digital image file, the digital image file is then made available to the Web client 27.

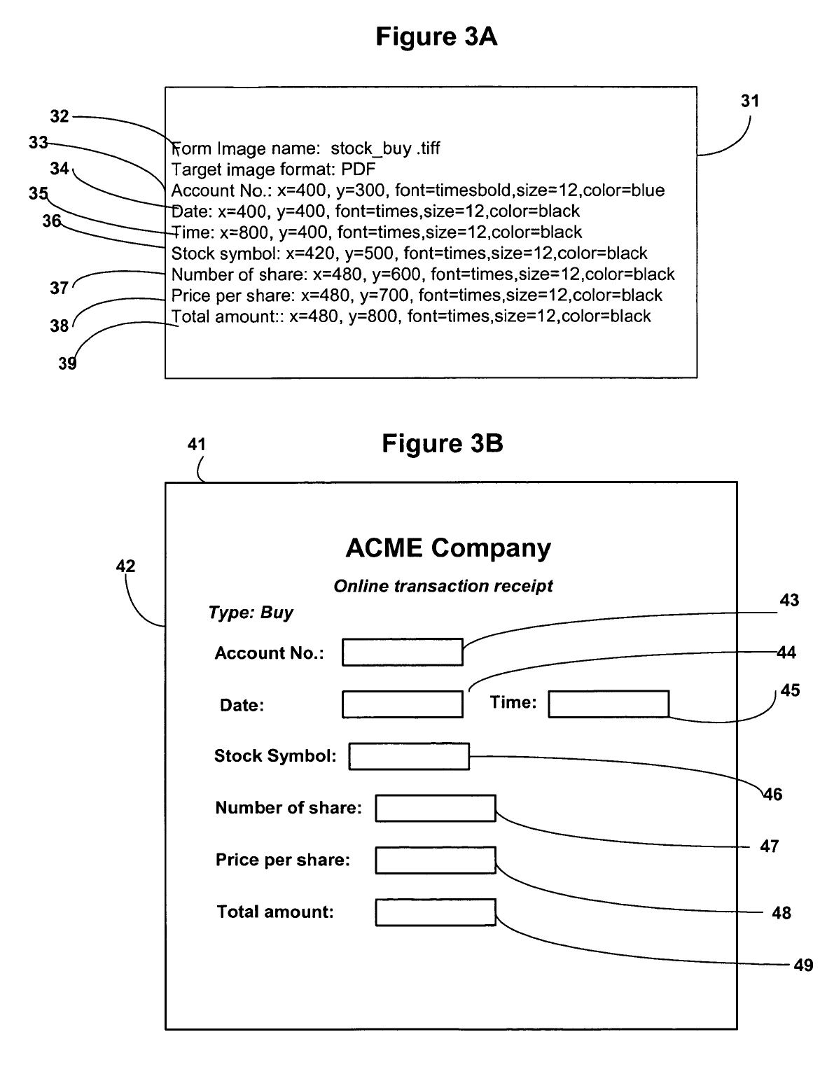

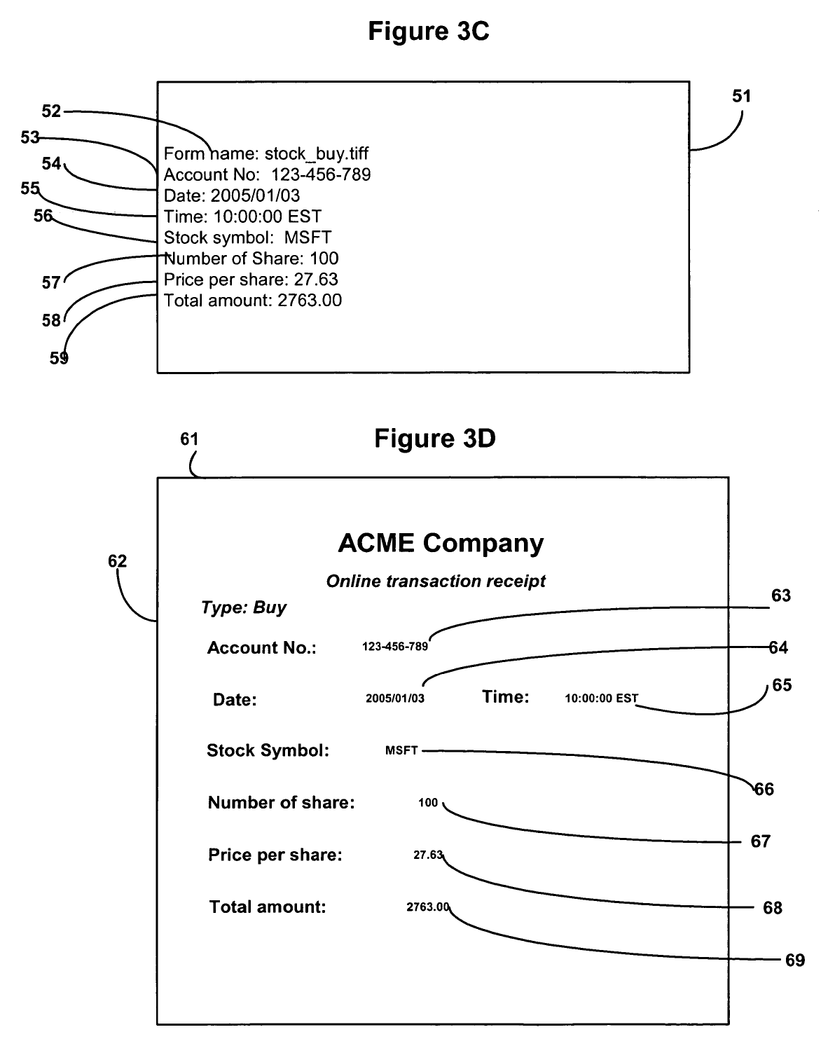

FIG. 3A and FIG. 3B show an embodiment of the invention in a stock trading application. The data field definition 31 is shown in FIG. 3A. The name of the form is stock_buy.tiff 32. The template image layout of stock_buy.tiff is shown in FIG. 3B. The X co-ordinate of the image 41 and the Y co-ordinate of the image 42 are used in the description of the location of data fields 33,34,35,36,37,38,39. The corresponding locations of these data fields are marked in the template image as 43,44,45,46,47,48,49. FIG. 3C is an instance of the data from the transaction storage 18. Fields 53,54,55,56,57,58,59 corresponds to the data layout definition of 33,34,35,36,37,38,39. FIG. 3D shows the resulting image after the data 53,54,55,56,57,58,59 of the transaction is drawn onto the template image 63,64,65,66,67,68,69 according to the X co-ordinate 61 and Y co-ordinate 62.

Instead of using a pre-defined template image and absolute XY co-ordinates to describe the location of the data fields in the layout, another embodiment that creates a bitmap image as a receipt is implemented by means of HTML on the server side. In this embodiment, the receipt image is similar to that of a Web browser. The receipt in HTML format is created in process 12. Instead of sending the HTML receipt to the Web client, a HTML interpreter is used in the image preparation process 13. The HTML interpreter interprets each HTML element into a data definition similar to that shown in FIG. 3A. The data fields together with labels are then drawn onto a pre-defined template image. The resulting image is then converted into a digital image file, and the digital image file is then made available to the Web client.

Another embodiment of the invention is illustrated by a drug prescription application that enables the doctor to use a Web client to order a drug prescription for a patient. Upon conformation of the transaction, a digital image of the prescription containing the letterhead and signature of the doctor-together with the drug name, dosage, patient name and usage instruction are drawn onto the TIFF image. The digital image is then sent to the pharmacy via electronic mail 19. The prescription image is then printed by the pharmacy as an official record for the prescription.

### OPERATION OF INVENTION—FIGS. 1, 2, 3A, 3B, 3C, 3D

A Web client initiates a transaction with a Web server by submitting a request to the transactional server. In FIG. 1, the Web server engages in an iterative dialogue with the Web client until the transaction is dismissed or confirmed. Transaction data is stored either in memory or in a temporary storage device such as hard disk storage. If the transaction is confirmed, the procedure depicted in FIG. 2 will be used to generate a digital image which comprises of a pre-set template image FIG. 3B and the data 51 from the transaction. The template image is prepared in advance and is part of the static content of the Web server. This template image is a piece of electronic paper. Since there is no restriction on the resolution of the image, the electronic paper can vary from a blank page to a high resolution complex business form. If a paper version of the form exists, this image can be a scanned image of the paper form using a resolution that is no less than that of a copy machine or a laser printer. The image form is then super imposed on a pixel grid and thus highlighting the X co-ordinate 41 and Y co-ordinate 42 of the image. The data field attributes are then noted:

Account number field has a XY co-ordinate of (400,300), using “times bold” font, with font size of 12 in blue color.

Date field has a XY co-ordinate of (400,400), using “times” font, with font size of 12 in black color.

Time field has a XY co-ordinate of (800,400), using “times” font, with font size of 12 in black color.

Stock symbol field has a XY co-ordinate of (420,500), using “times” font, with font size of 12 in black color.

Number of share field has a XY co-ordinate of (480,600), using “times” font, with font size of 12 in black color.

Price per share field has a XY co-ordinate of (480,700), using “times” font, with font size of 12 in black color.

Total amount field has a XY co-ordinate of (480,800), using “times” font, with font size of 12 in black color.

Once the data field attributes are determined, they are stored in disk storage together with the image file. During the execution of the transaction request 12, transaction data is gathered and stored in transaction storage 18. When a Web server receives request from a Web client to confirm the transaction, the transaction data is loaded into computer's memory from the transaction storage 18. From the transaction data, the name of the template image is determined. The name of the form is then loaded into computer's memory. The data descriptions FIG. 3A such as the type of font, the font size, color, and XY co-ordinate for each data field in the template image is retrieved from the disk file and loaded into computer's memory. For each data field required to be shown on the receipt, the data is read and drawn onto the template image according to the data description. Account number 53 is drawn onto the image 63. Date 54 is drawn onto the image 64. Time 55 is drawn onto the image 65. Stock symbol 56 is drawn onto the image 66. Number of share 57 is drawn onto the image 67. Price per share 58 is drawn onto the image 68. Total amount 59 is drawn onto the image 69.

The resulting image in the computer's memory is a graphical bitmap containing the image of the receipt FIG. 3D. The bitmap is then converted into an image file according to the pre-determined format 32. The image file is then made available to the Web client 16 over the Internet for display and print as a receipt 17. Optionally, the digital image file is sent as email attachment to an email client 19.

### SUMMARY, RAMIFICATION, AND SCOPE

Accordingly, the reader will see that a digital image document that is independent of the Web client interpretation results in a much higher degree of integrity. Although the preferred embodiment in the above discussion is in the context of a stock buying application, the advantage of having a process on the server side to create a digital image of on-demand document can extend far beyond the scope of a stock buying application. It should not be construed as limiting the scope of the invention but as merely providing illustrations of some of the presently preferred embodiment of this invention. For example, in a second embodiment, this invention is used in conjunction with a medical prescription application where a doctor prescribes medicine for a patient. An official prescription together with the doctor's signature and the doctor's letterhead in digital image is sent to a pharmacy to eliminate any doubt about the authenticity of the prescription information.

It is equally important to note that the method of using absolute positions to define the data field locations in the preferred embodiment should not be viewed as a limitation of this invention. The third embodiment has described a method of creating a digital image file by interpreting a HTML document on the server side. Document image created whether by means of a HTML document optionally drawing on a template image, or data optionally drawing on a template image using pre-defined attributes will deliver the same benefit offered by this invention. The digital image file received by the client, whether it is a Web client 16 or an e-mail client 19 will enjoy document integrity no less than the paper document issued by a brick and mortar establishment.

Thus the scope of the invention should be determined by the appended claims and their legal equivalents, rather than by the examples given.

We claim:

1. A method and procedure for a Web server application generating a digital image file as receipt for a Web based transaction, said method comprising:
a Web based transaction between a Web server and a Web client, and
upon confirmation of said transaction;
retrieve a template image for the said transaction;
retrieve descriptions of data fields of said transaction;
retrieve data from the said transaction;
draw said data onto said template image to create an output image file;
whereby the Web client can obtain a uniform receipt without relying on the client's Web browser and its environment.

2. A method and procedure as recited in claim 1 wherein said template image is a blank image.

3. A method and procedure as recited in claim 1 wherein said description of data fields are expressed in descriptive language syntax, including markup and script languages.

4. A method and procedure as recited in claim 1 wherein said template image is drawn by means of graphical languages.
